(19) United States
(12) Patent Application Publication
(10) Pub. No.: US 2009/0113504 A1
(43) Pub. Date: Apr. 30, 2009

(54) Digital Signal Converter Device

(75) Inventors: David Jackson, Manlius, NY (US); Noah Montana, Syracuse, NY (US); Ahmet Burak Olcen, Syracuse, NY (US)

Correspondence Address: ALSTON & BIRD LLP, BANK OF AMERICA PLAZA, 101 SOUTH TRYON STREET, SUITE 4000, CHARLOTTE, NC, 28280-4000, US

(73) Assignee: John Mezzalingua Associates, Inc.

(21) Appl. No.: 11/924,843

(22) Filed: Oct. 26, 2007

(51) Int. Cl. H04N 7/173

(52) U.S. Cl. 725/114

(57) ABSTRACT

A device converts a core group of digitally encoded broadcast television channels to analog NTSC signals. The analog NTSC signals are output simultaneously into frequency bands corresponding to conventional CATV broadcast bands. The device allows a conventional analog television receiver to function in a fully digital CATV system as if the analog television receiver were functioning in an analog CATV system. The subscriber selects the channel for viewing via the tuner at the analog receiver, not via the device.

### BACKGROUND OF THE INVENTION

The present disclosure relates to a system, method and apparatus for converting digitally encoded broadcast television channels signals to conventional analog broadcast television channels. More specifically, it relates to a digital signal converter device that receives digital channels and converts them to analog channels for viewing on a conventional television receiver.

Cable television (“CATV”) system operators traditionally have supplied conventional analog cable broadcast channels to subscribers. Many CATV system operators also offer digital cable broadcast channels. Digital cable can provide a greater range of services than conventional analog cable, and uses bandwidth more efficiently. A single conventional analog cable broadcast channel may require a bandwidth of 6 MHz. Multiple standard digital cable broadcast channels can be transmitted in one such 6 MHz frequency band. Each digital cable broadcast channel is digitally modulated with a method such as 64- or 256-Quadrature Amplitude Modulation (QAM) and can be further compressed by using an algorithm such as MPEG-2. Demand for bandwidth will only increase as more services such as new TV channels, multicast programs, HDTV, VOD, broadband internet, and VoIP are deployed by cable television system operators. As these services compete for the limited bandwidth allocated for use in CATV systems, it is likely that at some point CATV system operators may choose to eliminate conventional analog cable broadcast channels entirely.

If all cable broadcast channels become digital cable broadcast channels, conventional television receivers designed to process conventional analog cable broadcast channels only will be obsolete. Neither CATV system operators nor subscribers themselves will want to bear the cost of replacing multiple obsolete conventional television receivers. One possible way to avoid replacing an obsolete conventional television receiver is by use of a set top box. A set top box may include an internal digital receiver that can convert a digital cable broadcast channel to a conventional analog cable broadcast channel suitable for processing by a conventional television receiver. Set top boxes, however, may be unsuitable for large scale distribution in the event of a transition to all-digital cable broadcast channels. Set top boxes are large, expensive, and offer features that may not be of interest to some subscribers. Although a CATV system operator may agree to provide a set top box to the first television receiver in a household, the CATV system operator may refuse to provide, and the subscriber may not want, a set top box for each additional television in the same household.

Accordingly, a low-cost device that enables a conventional television receiver to process digital cable broadcast signals is desired. The device should be small and preferably unobtrusive to the subscriber. The device can be designed for compatibility with any digital cable broadcast format, including but not limited to those propounded by the Advanced Television Systems Committee (ATSC) and the Digital Video Broadcast (DVB) project.

### BRIEF SUMMARY OF THE DISCLOSURE

The present disclosure relates to a digital signal converter device that enables conventional television receivers to display digital channels in an all-digital CATV system. It may be installed inline with the input port of a conventional analog receiver. It may be manufactured at low cost and small size. Cost and size are reduced by limiting the operating frequencies to a selected few channels.

In one embodiment of a digital signal converter device, the CATV system operator transmits digital signals across the subscriber network. The CATV system operator designates one subband of the bandwidth to a small number of selected core broadcast channels for reception by a conventional television receiver equipped with the digital signal converter device as herein disclosed. The digital signal converter device simultaneously converts the digital channels and simultaneously outputs the corresponding analog channels. The subscriber then can use the tuner on the conventional television receiver to tune among the analog channels as if the head end were transmitting analog broadcast channels.

In another embodiment, the digital signal converter device may operate in connection to a computer. The computer may select digital channels from a full band and output to the digital signal converter device, which in turn converts these digital channels to corresponding analog channels. The software running on the computer may be implemented in the digital signal converter device, in which case a computer may not be needed.

In another embodiment, the digital signal converter device may receive the digital signals wirelessly, such as by WiFi or WiMAX, and convert them to the analog channels.

### BRIEF DESCRIPTION OF THE SEVERAL VIEWS OF THE DRAWINGS

Having thus described the disclosure in general terms, reference will now be made to the accompanying drawings, wherein:

FIG. 1 is a block diagram of a system in which one embodiment of the present invention may be used.

FIG. 2 is a flowchart of the operation of the system of FIG. 1.

FIG. 3 depicts relevant portions of the bandwidth at the input and output of the digital signal converter device of one embodiment of the present invention.

FIG. 4A is the exterior of one embodiment of the digital signal converter device of the present invention.

FIG. 4B is another embodiment of the digital signal converter device of the present invention.

FIG. 5 is a diagram of one embodiment of the digital signal converter device of the present invention.

FIG. 6 is a second diagram of an embodiment of the digital signal converter device of the present invention.

FIG. 7 depicts the frequency response of a bandpass filter for use with the present invention.

### DETAILED DESCRIPTION OF THE DRAWINGS

The present invention now will be described more fully hereinafter with reference to the accompanying drawings, in which some but not all embodiments of the inventions are shown. Indeed, these inventions may be embodied in many different forms and should not be construed as limited to the embodiments set forth herein; rather, these embodiments are provided so that this disclosure will satisfy applicable legal requirements. Like numbers refer to like elements throughout.

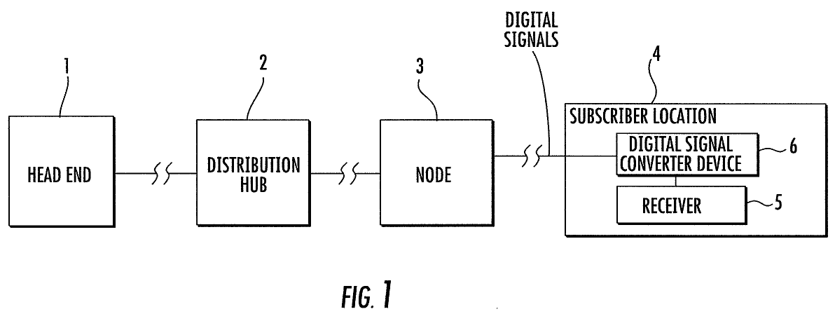

With reference to the drawings, in FIG. 1 there is a disclosed a block diagram of a hybrid fiber optic/coaxial CATV system in accordance with one embodiment of the present invention. The head end 1 is controlled by the CATV system operator. The head end receives broadcast television programming data representing broadcast channels from programming sources and distributes signals corresponding to the broadcast television programming data across a fiber optic cable system. In accordance with the present invention, the signals transmitted by the head end 1 are digitally encoded signals. The CATV system operator may encode broadcast television programming data in accordance with the MPEG-2 standard defined by the Moving Picture Experts Group (MPEG). Other digital encoding techniques are possible and are fully consistent with the present invention. The CATV system operator may apply error correction coding to the MPEG-2 encoded broadcast television programming data. The CATV system operator then modulates the digitally encoded broadcast television programming data. In one embodiment, the system operator uses 64-QAM, but other modulation schemes may also be used. Broadcast television programming can include many types of presentation content including content provided by large national networks and providers, content such as news and weather reports provided by regional and local station operators, and premium content such as that of movies and films and sporting events.

The digitally encoded signals from the head end may pass through one or more hubs 2 before reaching node 3. From the node, the signals are transmitted via coaxial cable to taps at the subscribers' locations 4. At least one subscriber has a conventional television receiver 5 incapable of processing the digitally encoded signals. In accordance with the present invention, the conventional television receiver 5 is equipped with a digital signal converter device 6.

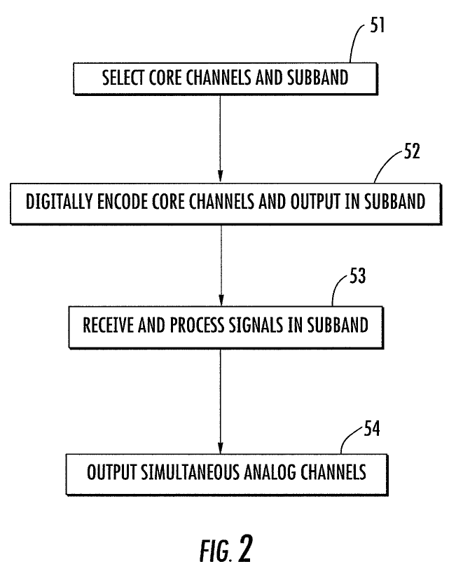

FIG. 2 depicts a flowchart representing the operation of the system of FIG. 1. In a first step 51, the CATV system operator dedicates a frequency subband to the provision of a fixed number of selected core broadcast channels. The selected core broadcast channels may be the broadcast channels currently available to analog cable subscribers. The CATV system operator selects the number of dedicated subbands and the number of channels occupying the dedicated subbands. In one embodiment, the CATV system operator dedicates one subband to six selected core broadcast channels. In a second step 52, the CATV system operator digitally encodes signals corresponding to broadcast television data representing the selected core broadcast channels and outputs the signals so that they occupy the dedicated subband. The CATV system operator digitally encodes signals corresponding to broadcast television data representing channels not included among the selected core broadcast channels and outputs the signals so that they occupy frequencies outside the dedicated subband. As shown at step 53, the digital signal converter device processes the digitally encoded signals in the dedicated subband but does not process the digitally encoded signals outside the dedicated subband. Finally, in step 54, the digital signal converter device simultaneously outputs analog broadcast television signals representing the selected core broadcast channels. In one embodiment, the analog broadcast television signals are output in NTSC format for reception by a conventional NTSC-capable television receiver.

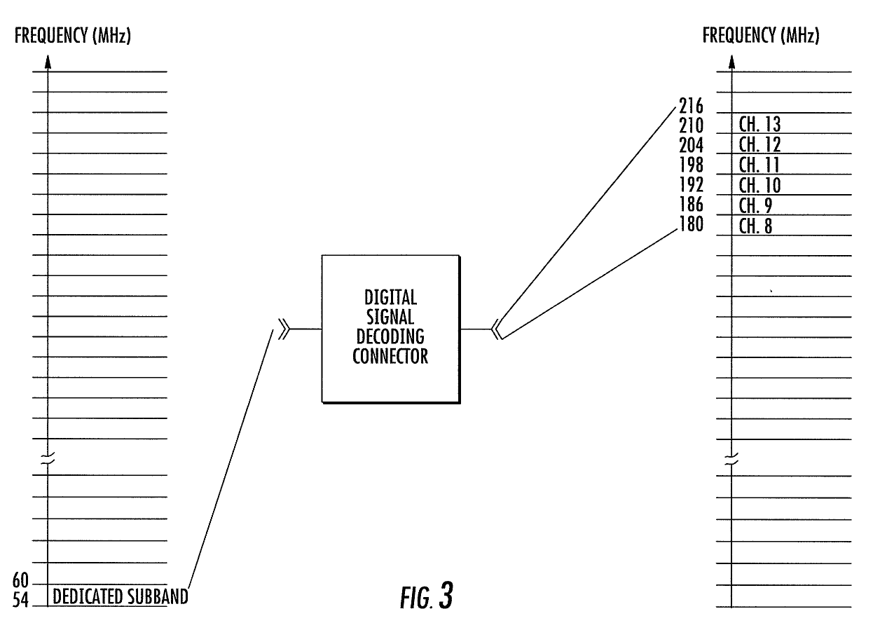

In FIG. 3, there is disclosed the relevant portions of the bandwidth at the input and output of the digital signal converter device of one embodiment of the present invention. The dedicated subband in this embodiment is between 54-60 MHz. The signals occupying this subband correspond to the selected core broadcast channels. The digital signal converter device processes the digitally encoded signals occupying the dedicated subband. It outputs analog broadcast television signals representing the selected core broadcast channels so that the analog signals representing each selected core broadcast channel occupy a conventional CATV broadcast band. In the embodiment of FIG. 3, there are six selected core broadcast channels occupying VHF channels 8-13 between 180 MHz and 216 MHz. Accordingly, a subscriber with this digital signal converter device attached to a conventional television receiver can switch among channels 8-13 by tuning the conventional analog receiver appropriately. While FIG. 3 expressly illustrates the conversion of six content selections from a contiguous dedicated subband between 54-60 MHz to a contiguously numbered set of channels 8-13, it should be understood that these descriptions relate as well to other examples wherein any number of content selections from one or more disparate subbands are converted to any contiguously or non-contiguously numbered set of channels. In one such other example, the content selections respectively outputted to the six channels 8-13 are converted from several subbands, each of the subbands providing one or more of the content selections. In this example, content selections provided by a scattering of subbands are converted to the gathered contiguous set of channels 8-13. In another such example, content selections provided by one or more subbands are converted to a non-contiguous scattering of channels. Thus, in this context, FIGS. 2-3 should be understood to relate to the conversion of content selections from any scattering of subbands to any scattering of channels.

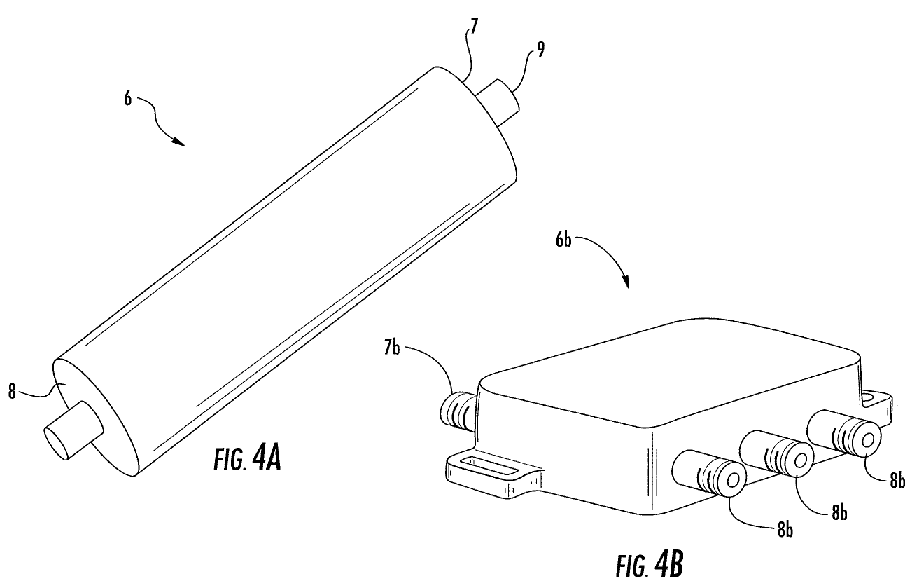

The exterior of one embodiment of the digital signal converter device is shown in FIG. 4A. The digital signal converter device 6 may be approximately cylindrical in shape with first and second ends perpendicular to the axis of the cylinder. The first end 7 interfaces with the coaxial cable 9 carrying the digitally encoded signals from the node 3. The second end 8 interfaces with the CATV input to the conventional television receiver 5. Another embodiment of the digital signal converter device is shown in FIG. 4B. The digital signal converter device 6b includes an input connector 7b that receives digitally encoded signals from the node 3. Multiple output connectors 8b provide decoded analog signals to respective receivers configured to process analog signals. In at least one example, the device 6b is deployed for use in a subscriber's home where multiple conventional television receivers are present. In that example, the device 6b is disposed to receive digitally encoded signals through the connector 7b as they enter the home and distributes analog channel content to the television receivers along cables leading from the connectors 8b to the receivers. Furthermore, in that example, the device 6b is disposed downstream of any two-way communication devices in the signal path.

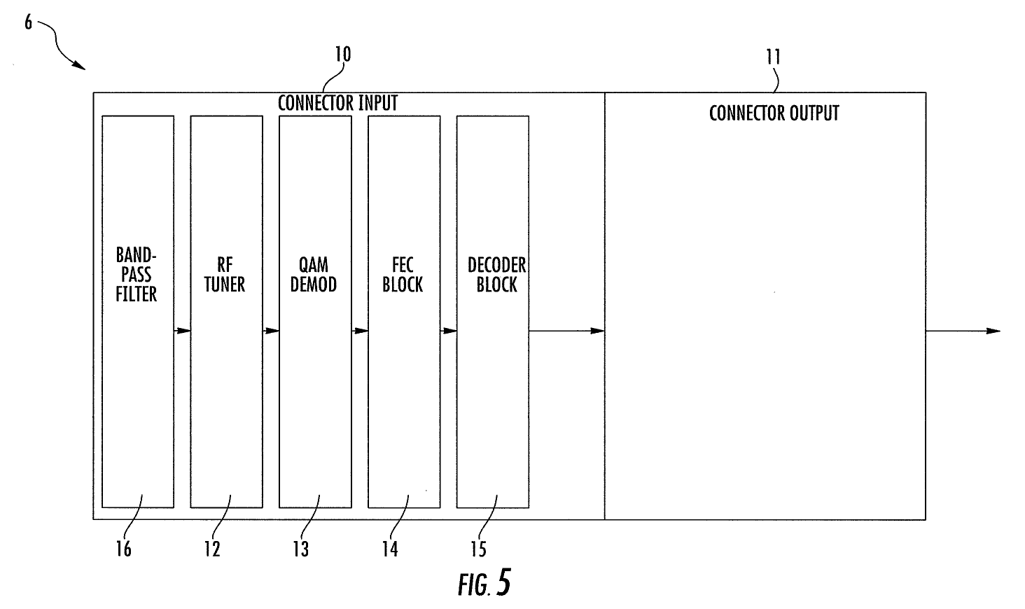

With reference to FIG. 5 there is disclosed a block diagram of one embodiment the digital signal converter device 6. The device 6 comprises a connector input portion 10 and a connector output portion 11. The connector input portion receives the digitally encoded signals from the head end and processes at least a subset of the signals to form digital broadcast television data. The precise design of both the connector input portion and the connector output portion will be tailored to the requirements of the system in which the device operates. As noted above, the device may be designed for compatibility with any digital CATV system. Requirements that can vary among systems include at least the types of modulation and encoding applied to the received signals and the frequencies at which the device receives and outputs signals. The exemplary embodiment of FIG. 5 is suitable for use in a system with MPEG-2 encoding, forward error correction (FEC), and QAM modulation. The connector input portion comprises an RF tuner 12, a QAM demodulator 13, a forward error correction block 14, and a decoder block 15. The data output from the decoder block are converted by the connector output portion 11 into analog broadcast television signals and can be output directly to the conventional television receiver 5. The connector input portion optionally further comprises a bandpass filter 16, discussed in further detail below.

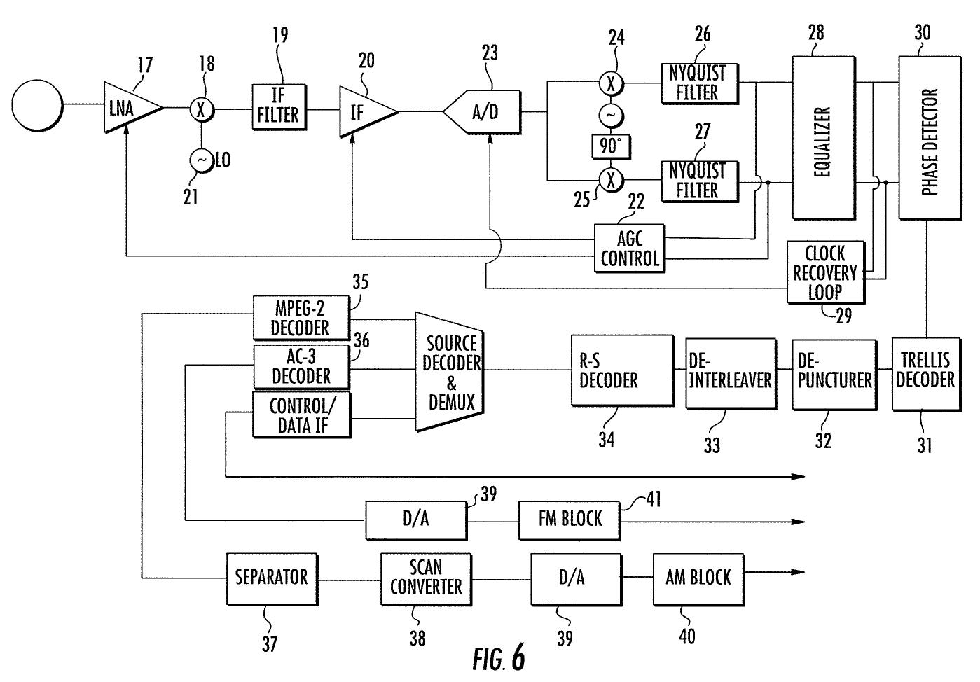

FIG. 6 depicts the block diagram of FIG. 5 in greater detail. The connector input portion is preferably fabricated as a single integrated circuit to reduce size, although multiple ICs or discrete components can be used. The connector input portion begins with an RF tuner that downconverts the received signals. The RF tuner comprises low noise amplifier 17 to boost the power of the received signals, mixer 18 that mixes the received signals with local oscillator 21 to downconvert the carrier frequency of the received signals from RF to IF, IF filter 19, and IF amplifier 20. The gain of both amplifiers 17 and 20 is adjusted by the output of automatic gain control block 22. The output of the IF amplifier 20 is input to analog to digital converter (ADC) 23 of the QAM demodulator block. The QAM demodulator includes multipliers 24 and 25 that multiply the digital data with the carrier and with the carrier delayed 90°, respectively, followed by Nyquist filters 26 and 27 to recover the in-phase and quadrature components. The in-phase and quadrature components are inputs to the automatic gain control block 22. The in-phase and quadrature components are also input to the equalizer 28, from which they are input to the clock recovery loop 29 for the ADC and the phase detector 30, which outputs the demodulated digital data. The FEC block in the embodiment of FIG. 6 applies the demodulated digital data to a trellis decoder 31 for maximum likelihood detection, a depuncturer 32, a deinterleaver 33, and a Reed-Solomon decoder 34 in order to recover corrected and demodulated digital data in the form of an MPEG-2 transport stream. The MPEG-2 transport stream is processed by the decoder block. The decoder block demultiplexes the transport stream into video, audio, and user interface components and decodes the video and audio in accordance with the MPEG-2 and Dolby Digital AC-3 standards, respectively. One MPEG-2 decoder 35 and AC-3 decoder 36 may be implemented for each selected core broadcast channel or, in the alternative, all selected core broadcast channels may share a single MPEG-2 decoder and AC-3 decoder. The MPEG-2 decoder and AC-3 decoder output decoded digital broadcast television data.

The connector output portion of FIG. 6 converts the decoded digital broadcast television data into analog broadcast television signals. In one embodiment of the present invention, the analog broadcast television signals are in NTSC format. The connector output portion includes a separator 37 to break the decoded digital broadcast television data into luminance and chrominance values, an interlaced scan converter 38 to render 525 interlaced scan lines, digital to analog converters 39, and an amplitude modulation block 40 to place the resulting analog broadcast television signals. The connector output portion further includes an audio frequency modulation block 41 for the audio data. In accordance with the NTSC format, the analog broadcast television signals representing each selected core broadcast channel occupy a 6 MHz bandwidth. The audio data for the channel occupy the highest 250 kHz of the 6 MHz band and a guard band occupies the lowest 250 kHz. These numbers and formats are exemplary only and the digital signal converter device should be designed for compatibility with the television receiver to which it connects.

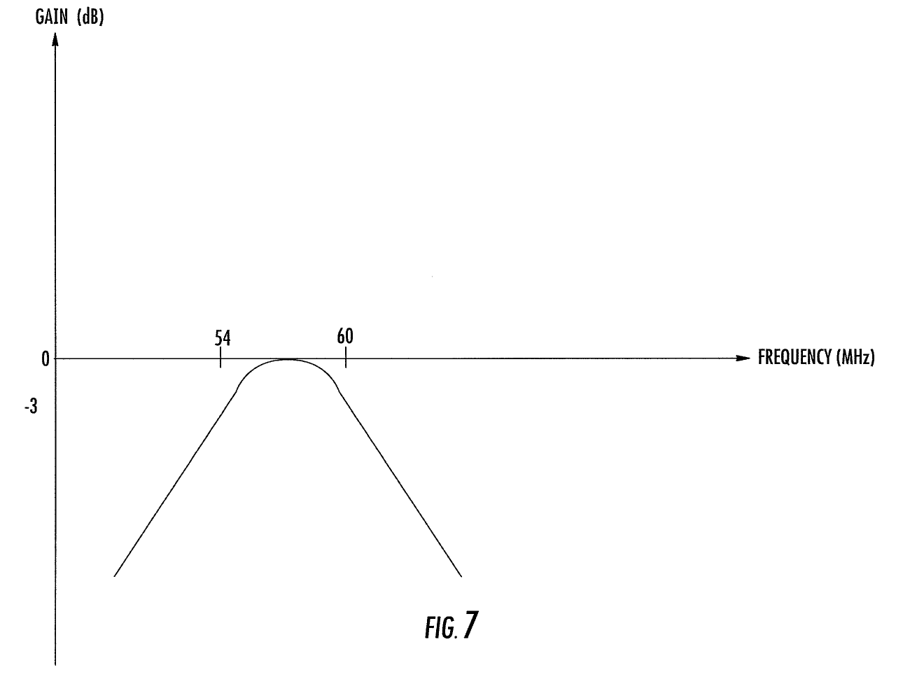

The RF tuner of FIG. 6 may include an optional bandpass filter. The bandpass filter passes signals in a frequency subband between a first frequency and a second frequency and attenuates signals outside that frequency subband. The bandpass filter may be any type of bandpass filter known in the art, including Butterworth and Chebyshev. FIG. 7 depicts the frequency response of the bandpass filter where the CATV system operator chooses a first frequency of 54 MHz and a second frequency of 60 MHz.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Although specific terms are employed herein, they are used in a generic and descriptive sense only and not for purposes of limitation.

That which is claimed:

1. A system for delivering video content to at least one receiver, including a first receiver configured for processing analog signals, the system comprising:
a head end for transmitting to the receivers digitally encoded signals in a frequency band between a first frequency and a second frequency, wherein the digitally encoded signals correspond to broadcast television data representing broadcast channels; and
a connector coupled to said first receiver, said connector comprising:
a connector input portion for receiving digitally encoded signals from a dedicated frequency subband and for decoding said digitally encoded signals from said frequency subband to form decoded digital broadcast television data; and
a connector output portion for converting said decoded digital broadcast television data into analog broadcast television signals,
wherein the analog broadcast television signals represent analog broadcast channels.

2. The system of claim 1, wherein each of said analog broadcast channels occupies a conventional broadcast band.

3. The system of claim 1, wherein said dedicated frequency subbands of said analog broadcast channels do not overlap.

4. The system of claim 1, wherein said analog broadcast channels are conventional CATV lowband and highband channels.

5. The system of claim 1, wherein said connector input portion further comprises a bandpass filter that attenuates frequencies less than the third frequency and greater than the fourth frequency.

6. A method for providing digitally encoded broadcast channels to a plurality of television receivers, said plurality of television receivers including at least a first conventional television receiver coupled to a digital signal converter device, comprising:
selecting a first set of broadcast channels, said first set being less than all available broadcast channels;
digitally encoding broadcast television data representing said first set of broadcast television channels to create a first set of digitally encoded broadcast television signals;
defining a frequency subband between a first frequency and a second frequency;
transmitting said first set of digitally encoded broadcast television signals in said frequency subband;
receiving, at said digital signal converter device, said first set of digitally encoded broadcast television signals;
converting, at said digital signal converter device, said first set of digitally encoded broadcast television signals into analog broadcast television signals;
modulating, at said digital signal converter device, said analog broadcast television signals to occupy conventional broadcast bands; and
providing simultaneously said analog broadcast television signals occupying conventional broadcast bands to said first conventional television receiver.

7. The method of claim 6, further comprising:
selecting a second set of broadcast television channels, said second set including at least one broadcast television channel not in said first set of broadcast television channels;
digitally encoding broadcast television data corresponding to said second set of broadcast television channels to create a second set of digitally encoded broadcast television signals; and
transmitting said second set of digitally encoded broadcast television signals outside said frequency subband;
attenuating, at said digital signal converter device, said second set of digitally encoded broadcast television signals outside said frequency subband.

8. The method of claim 7, wherein said digital signal converter device is a coaxial RF connector.

9. The method of claim 7, wherein said analog broadcast television signals are in NTSC format.

10. The method of claim 7, wherein said analog broadcast television signals are in PAL format.

11. A device for converting digitally encoded broadcast television signals received in a single downstream frequency band to analog broadcast television signals, said device comprising:
an input portion for receiving input signals corresponding to digitally encoded broadcast television data representing a plurality of broadcast television channels;
an RF tuning portion for not attenuating said input signals at frequencies between a first frequency and a second frequency greater than said first frequency and for attenuating input signals at frequencies less than said first frequency or greater than said second frequency;
a demodulating portion for converting said input signals to digital data and for demodulating said digital signals to form demodulated digital data;
an error correcting portion for correcting errors in said demodulated digital data to form corrected demodulated digital data;
a decoding portion for decoding said corrected demodulated digital data to form decoded corrected demodulated digital data; and
a converting portion for converting said decoded corrected demodulated digital data to analog signals and for encoding said analog signals in a format suitable for use by a conventional television receiver for processing analog signals.

12. A connector coupled to a fully digital CATV system comprising:
a connector input portion for receiving digitally encoded signals from a dedicated frequency subband of said digital CATV system and for decoding said digitally encoded signals from said dedicated frequency subband to form decoded digital broadcast television data; and,
a connector output portion for converting said decoded digital broadcast television data into analog broadcast television signals, wherein the analog broadcast television signals represent analog broadcast channels.
